(19) United States
(12) Patent Application Publication
(10) Pub. No.: US 2017/0234149 A1
(43) Pub. Date: Aug. 17, 2017

(54) NOZZLE BOX ASSEMBLY

(71) Applicant: DOOSAN HEAVY INDUSTRIES & CONSTRUCTION CO., LTD., Gyeongsangnam-do (KR)

(72) Inventor: Dongwoo KANG, Gyeonggi-do (KR)

(21) Appl. No.: 15/424,760

(22) Filed: Feb. 3, 2017

(30) Foreign Application Priority Data
Feb. 11, 2016 (KR) 10-2016-0015692

(51) Int. Cl. F01D 9/04; F01D 11/00

(52) U.S. Cl. CPC F01D 9/047; F01D 9/041; F01D 11/005; F05D 2220/31; F05D 2240/128; F05D 2240/55

(57) ABSTRACT

A nozzle box assembly includes steam inlets, through which working steam is supplied, a torus part connected to the steam inlets so as to form an annular steam path and having an opening portion, in which a part of the front surface of the annular steam path is opened, a bridge ring connected to the front surface of the torus part and having a bridge inside, and a steam path ring connected to the bridge ring so as to provide a path, which is connected to a stage, and provided with a plurality of vanes, wherein the bridge ring and the steam path ring are formed of the coupling of a plurality of divisions, which are divided in the circumferential direction thereof, and the divisions are coupled to the front surface of the torus part.

### CROSS-REFERENCE TO RELATED APPLICATION

The present application claims the benefit of Korean Patent Application No. 10-2016-0015692 filed in the Korean Intellectual Property Office on Feb. 11, 2016, the entire contents of which are incorporated herein by reference.

### BACKGROUND

The present disclosure relates to a nozzle box assembly and, more particularly, to a nozzle box assembly provided to the stage inlet of a steam turbine so as to inject steam to the stage.

A nozzle box assembly for a steam turbine, as shown in FIG. 1 and FIG. 2, includes three constituent elements, that is, a torus 14, a bridge ring 16 and a steam path ring 12. Each of the constituent elements is prepared as a 180° segment in the initial stage and then the constituent elements are welded in sequence so as to form two nozzle box halves 18. FIG. 1 and FIG. 2 show one of the nozzle box halves 18, wherein the other one also has the same shape and structure.

Next, the two halves 18 are joined together along a horizontal center line so as to form a nozzle box assembly for a steam turbine. Each of the nozzle box halves 18 includes one or more steam inlets 10, which are integrally formed with the torus 14. The steam inlets 10 are connected to the torus 14 on a plane surface, which is perpendicular to the rotation shaft of the turbine.

During the operation of the steam turbine, steam from a steam supply source such as a boiler and the like is introduced through the steam inlets 10 and flows in the torus 14. The flow direction of the steam is typically changed to the axial direction such that the steam flows through the annular opening of the bridge ring 16 to the inside of the steam path ring 12. The steam path ring 12 is provided with a series of nozzles, including airfoil vanes 13 for directing the steam flow.

The nozzle box assembly as described above has the configuration, in which the torus 14, the bridge ring 16 and the steam path ring 12 are coupled together. More specifically, as for this coupling, the bridge ring 16 and the steam path ring 12 are respectively formed in advance and then the steam path ring 12 is welded to the bridge ring 16 after the bridge ring 16 is welded to the torus 14, thereby achieving the mutual welding.

The coupling method as above employs a method for forming each of the bridge ring 16 and the steam path ring 12 integrally or in a semicircular body. In this case, if partially defective bridge rings 16 or vanes 13 are generated in the process of manufacture, the whole product has to be abandoned. Therefore, the coupling method is inefficient in terms of manufacture and excessive labor is required for the welding.

Further, if the bridge ring 16 or the vane 13 is partially damaged during the operation of the steam turbine, the welding coupling has to be released and then the whole bridge ring 16 or the steam path ring 12 has to be replaced, resulting in the difficulty of maintenance.

### BRIEF SUMMARY

Accordingly, the present disclosure has been made to address the above-mentioned problems, and it is an objective of the present disclosure to provide a nozzle box assembly, in which the efficiency of manufacturing procedure is improved and, when a part is damaged, it is possible to simply replace the corresponding part.

To accomplish the above objective, according to the present disclosure, there is provided a nozzle box assembly, including: steam inlets, through which working steam is supplied; a torus part connected to the steam inlets so as to form an annular steam path and having an opening portion, in which a part of the front surface of the annular steam path is opened; a bridge ring connected to the front surface of the torus part and having a bridge inside; and a steam path ring connected to the bridge ring so as to provide a path, which is connected to a stage, and provided with a plurality of vanes, wherein the steam path ring is formed of the coupling of a plurality of divisions arranged along the circumferential direction thereof and the divisions are coupled to the front surface of the torus part.

In addition, each of the divisions may include at least one or more bridges and vanes.

Meanwhile, the division may include a protrusion coupling part, which is protruded in the backward direction, and the front surface of the torus part may include a depression coupling part, to which the protrusion part is coupled.

Further, the protrusion coupling part and the depression coupling part may respectively have a coupling section in a dovetail shape, and the protrusion coupling part may be fitted into the depression coupling part along the circumferential direction.

Besides, the dovetail shape may include at least one or more wrinkled side portions.

In addition, the divisions, which are connected to neighboring divisions, respectively include a protrusion sealing part formed on one of side surface portions thereof and a depression sealing part formed on the other one side surface portion, such that the protrusion sealing parts and the depression sealing parts of the neighboring divisions are connected to each other through mutual engagement so as to carry out sealing of the side surface portions.

Meanwhile, the nozzle box assembly may further include an annular sealing plate provided to be fitted into annular sealing grooves, which are formed on top of joint surfaces of the divisions and the torus part, which are coupled to each other.

Besides, the nozzle box assembly may further include an elastic sealing member disposed between the bottom surface of the sealing plate and the bottom surface of the sealing groove.

Further, a flange part may be respectively provided to the rear surface edges of the divisions and the front surface edge of the torus part such that the divisions are coupled to the torus part by the coupling of the flanges.

In addition, the nozzle box assembly may further include a restraining ring for surrounding the edges of the divisions.

The nozzle box assembly according to the present disclosure described as above is formed by coupling the divisions provided to the steam path ring and the bridge ring, thereby increasing the manufacturing efficiency.

Further, it is possible to achieve stable coupling of the torus part through the engagement of the protrusion coupling part and the depression coupling part, thereby replacing the welding.

Meanwhile, it is also possible to achieve stable coupling of the torus part by providing the flange parts, thereby replacing the welding.

In addition, even though the divisions are employed, the leakage of combustion gas can be reduced or minimized between the divisions by the protrusion sealing part and the depression sealing part. Also, the leakage of the combustion gas may be minimized between the divisions and the torus part by providing the sealing plate and the elastic sealing member.

Besides, it is possible to reduce or prevent the decrease of structural strength, which may be possibly caused by the employing of the divisions, by providing the outer restraining ring and the inner restraining ring.

### BRIEF DESCRIPTION OF DRAWINGS

FIG. 1 is a perspective view of a nozzle box assembly.

FIG. 2 is a cross-sectional view of a nozzle box assembly.

FIG. 3A is a perspective view of a division according to an embodiment of the present disclosure.

FIG. 3B is a perspective view of coupling of a plurality of divisions.

FIG. 4 is a diagram of a coupler according to an embodiment of the present disclosure.

FIG. 5 is a diagram illustrating a protrusion coupling part and a depression coupling part according to an embodiment of the present disclosure.

FIG. 6 is a diagram illustrating a sealing plate and an elastic sealing member according to an embodiment of the present disclosure.

FIG. 7 is a diagram illustrating a protrusion coupling part and a depression coupling part according to an embodiment of the present disclosure.

FIG. 8A is a diagram illustrating a protrusion sealing part and a depression sealing part according to an embodiment of the present disclosure.

FIG. 8B is a cross sectional view taken along line A-A in FIG. 8A.

FIG. 8C is a cross sectional view taken along line B-B in FIG. 8C.

FIG. 9 is a perspective view illustrating a division, which employs the protrusion sealing part and the depression sealing part, according to the embodiment of the present disclosure.

FIG. 10 shows flange parts according to an embodiment of the present disclosure.

FIG. 11 shows restraining rings according to an embodiment of the present disclosure, and

FIG. 12 is a diagram illustrating a coupler in the shape of a saw-tooth according to an embodiment of the present disclosure.

### DETAILED DESCRIPTION

Hereinafter, with reference to the attached drawings, embodiments of the present disclosure will be described in detail. In connection with adding reference signs to the elements in each of the drawings, the same elements have the same reference signs as far as possible even though they are illustrated in different figures.

In addition, the terms such as first, second, A, B, a, b and the like can be used in explaining the elements of the example embodiments of the present disclosure. These terms are simply used to distinguish corresponding elements from other elements but not intended to limit the nature of the corresponding component elements by the terms. Additionally, it should be also understood that the expression that some component is “connected”, “coupled” or “linked” to another component means that some component is directly connected to another component or is indirectly “connected”, “coupled” or “linked” to another component through a further component interposed between each of the components.

### LEGEND OF REFERENCES NUMERALS IN DRAWINGS

12: steam path ring

13: vanes

14: torus part

15: bridge

16: bridge ring

20: divisions

21: protrusion sealing part

22: recess

30: coupler

31, 32: protrusion coupling part

31′, 32′: recesses

33, 33′: saw-tooth portion

35, 35′: flange part

36: coupling screw

37: outer restraining ring

38: inner restraining ring

40: sealing plate

41: elastic sealing member

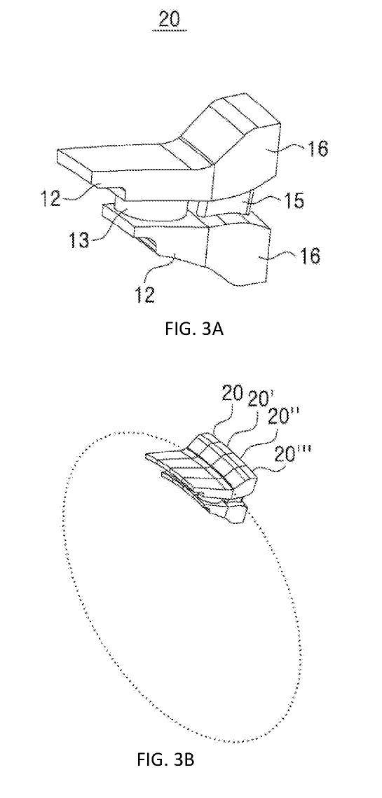

FIG. 3 shows the structure of a division 20 according to the present disclosure.

A nozzle box assembly according to the present disclosure includes steam inlets, through which working steam is supplied, a torus part 14, which is connected to the steam inlets so as to form an annular steam path and has an opening portion, in which a part of the front surface of the annular steam path is opened.

The torus part 14 is connected to a bridge ring 16 and a steam path ring 12, wherein the bridge ring 16 is connected to the front surface of the torus part 14 and has a bridge 15 therein. Further, the steam path ring 12 is connected to the front surface of the bridge ring 16 so as to provide a path, which is connected to a stage, and has a plurality of vanes provided therein.

FIG. 3 shows the steam path ring 12 and the bridge ring 16, which are formed of the coupling of a plurality of divisions 20, in which FIG. 3(a) shows a single one of the divisions 20 and FIG. 3(b) shows that the plurality of divisions 20, which are connected to each other in the circumferential direction. Even though FIG. 3(b) shows that totally four divisions 20 are coupled as an example, a plurality of divisions 20 are further provided throughout the remaining section displayed by a circular dotted line such that the entire plurality of divisions 20 form a ring shape. That is, the bridge ring 16 and the steam path ring 12 are formed by coupling the plurality of divided divisions 20, which are connected to each other along the circumferential direction. Each of the divisions 20 is coupled to the front surface of the torus part 14.

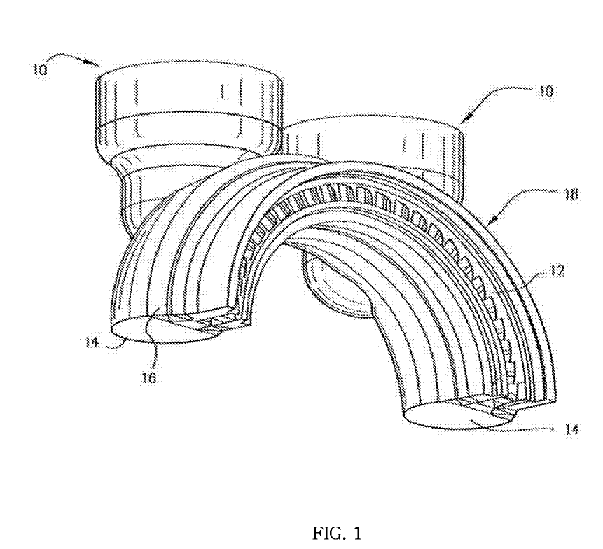

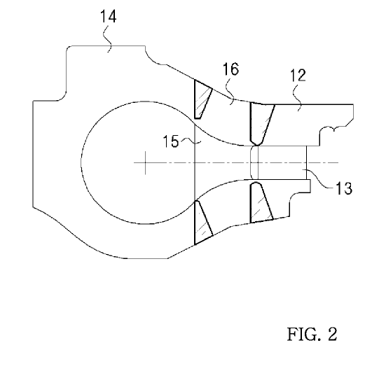

As shown in FIG. 3(a), it is preferable that the division 20 includes at least one or more bridges 15 and at least one or more vanes 13. As mentioned hereinabove, as the divisions 20 are connected to each other into a shape of a ring, the bridges 15 and the vanes 13 are also arranged in an annular shape as shown in FIG. 1 and FIG. 2, wherein each of the bridges 15 and the vanes 13 serves as a support to connect the upper portions and the lower portions of the steam path ring 12 and the bridge ring 16. Therefore, it is preferable in terms of structural strength of the divisions 20 that the single division 20 includes at least one or more bridges 15 and at least one or more vanes 13.

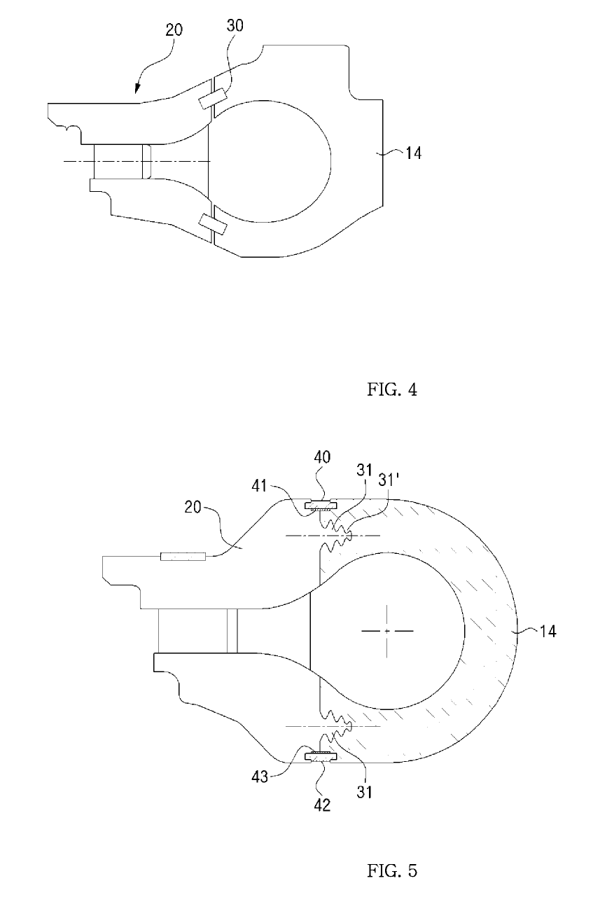

Meanwhile, FIG. 4 is a conceptual diagram for showing the coupling between the divisions 20 and the torus part 14.

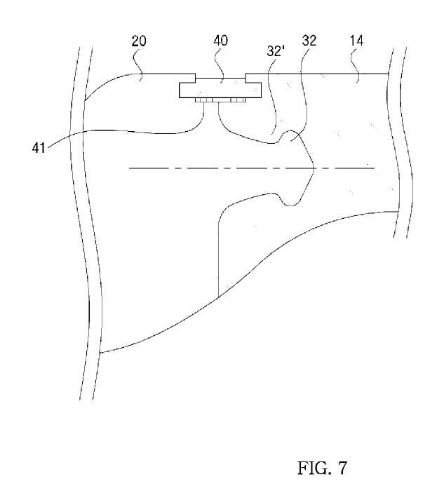

Referring to FIG. 4, the division 20 and the torus part 14 respectively have recessed portions at both sides thereof and couplers 30 are fitted between the recessed portions. It is also conceivable that the division 20 includes protrusion coupling parts 31, 32, which are protruded in the backward direction, and the torus part 14 includes recesses 31′, 32′, which are formed on the front surface of the torus part 14 so as to be coupled with the protrusion coupling parts 31, 32, as shown in FIG. 5 and FIG. 7.

Meanwhile, the protrusion coupling parts 31, 32 and the recesses 31′, 32′ respectively have a coupling section in a dovetail shape such that the protrusion coupling parts 31, 32 are fitted into the recesses 31′, 32′ along the circumferential direction, as shown in FIG. 7. If the division 20 and the torus part 14 are coupled in the shape of a dovetail, sliding movement in the circumferential direction and coupling can be achieved while movement in the normal direction of joint surfaces is limited, such that stable coupling is maintained.

Further, in order to increase the sealing effect and the strength of the joint surfaces, it is preferable that the dovetail shape includes at least one or more wrinkled side portions, as shown in FIG. 5.

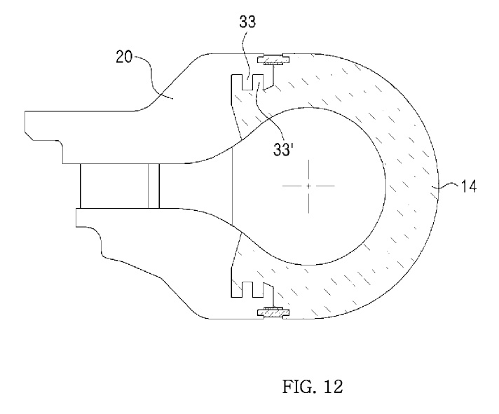

Meanwhile, the coupler 33, 33′ in the shape of a saw-tooth 33, 33′, as shown in FIG. 12. That is, a saw-tooth portion 33′ formed on the front surface of the torus part 14 is engaged with the saw-tooth portion 33 formed on the rear surface of the division 20 through mutual male-and-female engagement.

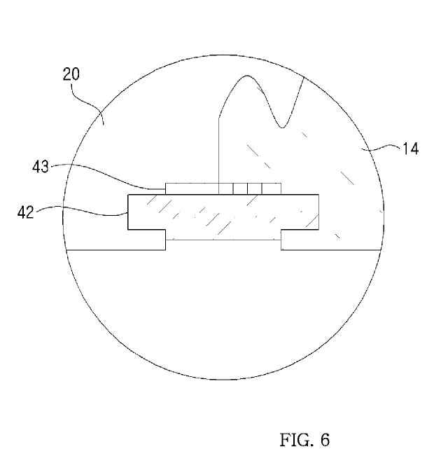

Meanwhile, as shown in FIG. 5 and FIG. 6. annular sealing grooves may be provided to the top portions of the joint surfaces of the divisions 20 and the torus part 14, which are coupled with each other, and an annular sealing plate 40 is further provided so as to be fitted into the sealing grooves.

The sealing problem of the combustion gas of high temperature and high pressure, which may occur in such a structure, may be alleviated by coupling the divisions 20 and the torus part 14 with each other through the mutual fitting in a dovetail shape, which may avoid the need for welding.

The sealing plate 40 can carry out the sealing in a direct surface contact state with respect to the sealing grooves. Meanwhile, an elastic sealing member 41, for example, a rubber plate and the like, may be further provided between the bottom surface of the sealing plate 40 and the bottom surface of the sealing groove.

In addition to such a rubber plate, materials which have elastic force, between the bottom surface of the sealing plate 40 and the bottom surface of the sealing groove, as the elastic sealing member 41, may be used to increase the sealing performance.

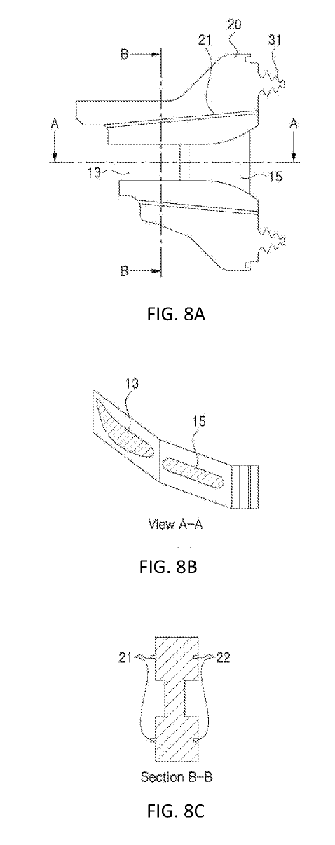

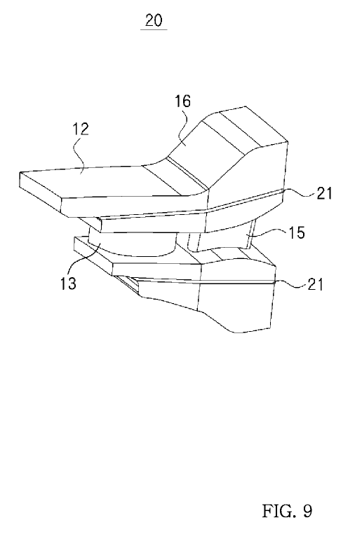

Meanwhile, FIGS. 8 and FIG. 9 show a protrusion sealing part 21 and a recess 22, which are provided to the side surface of the division 20.

More specifically, the divisions 20, which are connected to neighboring divisions, respectively include the protrusion sealing part 21 formed on one of side surface portions thereof and the recess 22 formed on the other side surface portion. Therefore, the protrusion sealing parts 21 and the recess 22 of the neighboring divisions are engaged with each other so as to carry out the sealing of the side surface portions.

That is, if the protrusion sealing part 21 is provided to the right side surface of the individual division 20, the recess 22 is provided to the right side surface thereof. The right side surface of one division 20 is connected to the left side surface of a neighboring division 20 thereof, wherein the protrusion sealing part 21 is fitted in the recess 22.

The protrusion sealing part 21 and the recess 22, as mentioned above, carry out the function as a seal for preventing the high temperature and high pressure combustion gas inside the divisions 20 from leaking to the outside and, simultaneously, the function as a guide in the mutual coupling of the divisions 20 so as to restrain the mutual movement of the divisions 20.

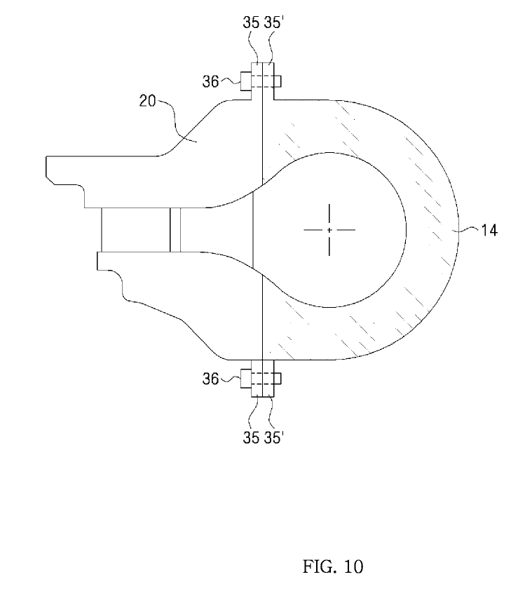

Meanwhile, FIG. 10 shows a flange coupling method of the divisions 20 and the torus part 14.

More specifically, flange parts 35, 35′ are respectively provided to the rear surface edges of the divisions 20 and the front surface edge of the torus part 14, and the divisions 20 are coupled to the torus part 14 by the coupling of the flanges 35, 35′. The flange coupling as mentioned above has an advantage that it is possible to carry out the coupling in a relatively simple structure, compared with the method of using the protrusion coupling parts 31, 32 and the recesses 31′, 32′ as mentioned hereinabove.

An additional sealing member may also be provided between the flanges so as to reinforce the sealing.

Meanwhile, since the above-mentioned coupling of the divisions 20 may be weak in terms of expansion, compared with the integral bridge ring 16 or the steam path ring 12, a restraining ring may be further provided so as to surround the edges of the divisions 20.

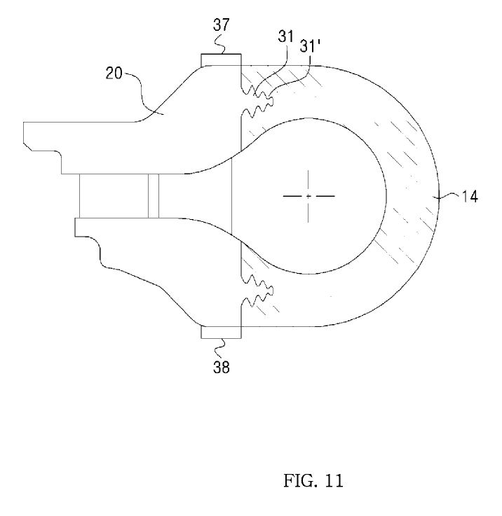

Such a restraining ring may be divided into an outer restraining ring 37 for surrounding the annular outer surface and an inner restraining ring 38 for surrounding the annular inner surface, as shown in FIG. 11, thereby respectively suppressing the expansion of the outer surface and the inner surface.

Hereinabove, even though all the constituent elements which form the embodiments of the present disclosure are explained to be coupled as a single body or operating as a single body in combination, the present disclosure is not necessarily limited to these embodiments. That is, within the purpose of the present disclosure, one or more of all the constituent elements can be selectively coupled to operate. In addition, it should be understood that the terms of “include”, “form” or “have” used hereinabove mean that corresponding constituent elements can be inherent, unless otherwise defined, and thus shall be construed as that any other constituent elements are not excluded but may be further included. All the terms including all technical and scientific terms have, unless otherwise defined, the same meaning as commonly understood by a person skilled in the art, to which the present invention belongs.

It will be apparent to those skilled in the art that various changes and modifications may be made without departing from the spirit and scope of the following claims.

Moreover, the above advantages and features are provided in described embodiments, but shall not limit the application of the claims to processes and structures accomplishing any or all of the above advantages.

What is claimed is:

1. A nozzle box assembly, comprising:
steam inlets operable to supply working steam;
a torus part coupled to the steam inlets to provide an annular steam path and having an opening portion, a part of a front surface of the annular steam path being open;
a bridge ring coupled to a front surface of the torus part and having a bridge portion proximal an interior portion of the bridge ring; and
a steam path ring coupled to the bridge ring to provide a path with a plurality of vanes,
wherein the bridge ring and the steam path ring include a plurality of divisions coupled together, the divisions being arranged along a circumferential direction of the nozzle box assembly, and the divisions are coupled to the front surface of the torus part.

2. The nozzle box assembly according to claim 1, wherein each of the divisions includes one or more of the bridges and one or more of the vanes.

3. The nozzle box assembly according to claim 1, wherein the divisions each include a protrusion coupling part, and the front surface of the torus part includes a plurality of recesses to which the protrusion parts are respectively coupled.

4. The nozzle box assembly according to claim 3, wherein the protrusion coupling parts and the recesses respectively have coupling section in a dovetail arrangement, and the protrusion coupling parts are respectively disposed in the recesses along the circumferential direction.

5. The nozzle box assembly according to claim 4, wherein the dovetail shape includes at least one or more wrinkled side portions.

6. The nozzle box assembly according to claim 1, wherein
neighboring divisions are coupled to each other,
the neighboring divisions respectively include a protrusion sealing part formed on a first side surface portion and a recess defined in a second side surface portion, and
the protrusion sealing parts and the recesses the neighboring divisions are engaged with each other so to seal the first and second side surface portions.

7. The nozzle box assembly according to claim 1, further comprising an annular sealing plate operable to be disposed into annular sealing grooves of joint surfaces of the divisions and the torus part, wherein the joint surfaces of the divisions are coupled to the torus part.

8. The nozzle box assembly according to claim 7, further comprising an elastic sealing member disposed between a bottom surface of the sealing plate and bottom surfaces of the sealing grooves.

9. The nozzle box assembly according to claim 1, wherein
each of the divisions includes a first flange part disposed at a rear surface edge of the division and a second flange part disposed at a front surface edge of the torus part, and
the divisions are coupled to the torus part by the coupling of the flanges.

10. The nozzle box assembly according to claim 1, further comprising a restraining ring that surrounds edges of the divisions.
